(19) United States
(12) Patent Application Publication
(10) Pub. No.: US 2006/0137943 A1
(43) Pub. Date: Jun. 29, 2006

(54) Brake shoe for a disk brake

(76) Inventors: Gerhard Mayrhofer, St. Georgen/Gusen (AT); Volker Foge, Ebensee (AT); Gerhard Hartner, Bad Wimsbach - Neydharting (AT)

Correspondence Address: WILLIAM COLLARD;COLLARD & ROE, P.C., 1077 NORTHERN BOULEVARD, ROSLYN, NY, 11576, US

(21) Appl. No.: 11/248,476

(22) Filed: Oct. 12, 2005

(30) Foreign Application Priority Data
Oct. 12, 2004 (AT) A1697/2004

(51) Int. Cl. F16D 65/04; F16D 69/00

(52) U.S. Cl. 188/250 B

(57) ABSTRACT

A brake shoe (2) is described for a disk brake with a support (7) for a sintered brake lining, which support can be pressurized by the piston (5) of at least one brake cylinder (4). In order to provide advantageous constructional conditions it is proposed that the support (7) comprises on the side facing the piston (5) of the brake cylinder (4) a heat-insulating, porous pressure transfer body (9) made of fibers bonded with artificial resin for the piston.

### 1. FIELD OF THE INVENTION

The invention relates to a brake shoe for a disk brake with a support for a sintered brake lining, which support can be pressurized by the piston of at least one brake cylinder.

### 2. DESCRIPTION OF THE PRIOR ART

Sintered brake linings for brake shoes of a disk brake combine the advantages of favorable resistance to wear and tear and a substantially constant coefficient of friction as a precondition that a high brake energy can be converted in such disk brakes, which entails a respectively high temperature load on the sintered brake linings. The metallic share of the sintered brake linings leads to a favorable thermal conductivity, thus leading to a discharge of heat to the supports of the brake shoes which carry the supports and thus to a heat transmission from the brake shoes to the pistons of the brake cylinders which transfer the brake force onto the brake shoes. The brake liquid is heated via the pistons of the brake cylinders, which upon reaching the critical threshold temperature for the brake fluid endangers the proper functioning of the disk brakes. For this reason, the use of brake shoes with sintered brake linings is only suitable to a limited extent for converting high brake energies, although such sintered brake linings would advantageously meet the occurring load requirements.

In order to achieve effective silencing in disk brakes with partial linings, it is known (DE 40 23 514 A1) to provide steel segments on the side of the supports which is averted from the brake shoes, which steel segments are joined to the supports via an elastomer layer, so that the elastomer layer substantially prevents a transmission of oscillations from the supports to the caliper via the pistons of the brake cylinders. This elastomer layer also entails a heat insulation of said disk brakes with partial linings, but such heat insulation is insufficient in the use of sintered friction linings in order to protect the brake liquid provided for actuating the brake cylinders from impermissible heating.

### SUMMARY OF THE INVENTION

The invention is thus based on the object of providing a brake shoe for a disk brake of the kind mentioned above in such a way that the high thermal load capacity of sintered brake linings can be utilized advantageously for converting high brake energies without having to fear any thermal overload of the brake liquid.

This object is achieved by the present invention in such a way that the support comprises on the side facing the piston of the brake cylinder a heat-insulating, porous pressure transfer body made of fibers bonded with artificial resin for the piston.

By providing a heat-insulating, porous pressure transfer body made of fibers bonded with artificial resin, a sufficient heat insulation between the brake shoe and the piston of the brake cylinder is surprisingly achieved in order to protect the brake fluid from thermal overload. This is apparently achieved in such a way that not only is the adverse thermal conductivity of the employed fibers and plastic materials utilized, but the porosity of such a pressure transfer body increases the insulating effect accordingly. Notice must be taken concerning the porosity of the pressure transfer body that the porosity must not impair the compressive strength concerning the brake forces transmitted onto the brake shoes.

Although different synthetic and natural fibers can be used under the respective preconditions concerning thermal conductivity and temperature stability, especially advantageous constructional conditions are obtained when at least a predominant share of the fibers consist of carbon fibers. The fibers per se can be used in the form of a non-woven material or in the form of fiber strands processed into fabrics or knitted fabrics in several layers in order to obtain a thickness of the pressure transfer body which is sufficient for heat insulation. For reasons of strength, the thickness of the pressure transfer body should not exceed half the thickness of the support for the brake lining. If a minimum thickness of a quarter of the support thickness is provided for the pressure transfer body, the usual requirements concerning the insulating effect can be easily met by taking into account the required compressive strength.

Although it is principally possible to set up the pressure transfer body on the side of the support facing the piston of the brake cylinder, simpler constructional conditions are obtained when the pressure transfer body is inserted into a recess of the support for the brake lining, so that the dimensions of the shoes remain unchanged in the direction of pressurization of the brake cylinders.

### BRIEF DESCRIPTION OF THE DRAWINGS

The subject matter of the invention is shown by way of example in the drawings, wherein:

FIG. 1 shows a disk brake with the brake shoes in accordance with the invention in a schematic sectional view, and

FIG. 2 shows a view of a brake shoe from the side facing the brake cylinder.

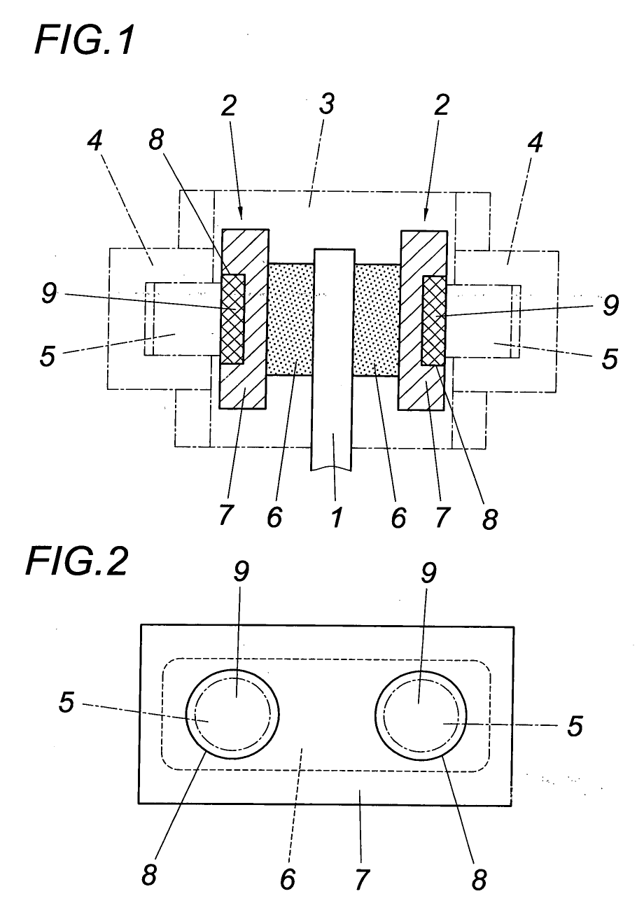

According to FIG. 1, the schematically indicated disk brake comprises a brake disk 1 with two brake shoes 2 which are arranged on either side of the brake disk 1, are held in a caliper 3 and are pressurized with the help of a brake cylinders 4 whose pistons are designated with reference numerals 5. The brake shoes 2 per se comprise a sintered brake lining 6 which is fastened to a support 7, e.g. by soldering.

In contrast to conventional disk brakes of this kind, the supports 7 for the brake linings 6 are provided on the side averted from the brake linings 6 with recesses 8 for receiving heat-insulating pressure transfer bodies 9 for the pistons 5 of the brake cylinders 4. These pressure transfer bodies 9 consist of fibers which are bonded with artificial resin and have at least a predominant share of carbon fibers.

The bonding of said fibers occurs preferably with the help of high-temperature-resistant epoxy or phenolic resins. Due to the incomplete embedding of the fibers in the bonding resin, the pressure bodies 9 have a porosity which, in combination with the low conductivity of the fibers and the bonding resin, ensures an effective heat insulation, so that a heat transmission from the support 7 to the piston 5 of the respective brake cylinder 4 can be prevented to an extent which excludes an impermissible increase in the temperature of the brake fluid for pressurizing the brake cylinders 4 by the brake energy converted in the sintered friction lining 6. The precondition is that the support of the pistons 5 on the brake shoes 2 occurs exclusively via the heat-insulating pressure transfer bodies 9, whose diameters must therefore be larger than those of the piston 5.

The fibers of the insulating body 9 can be inserted in the form of a non-woven material. It is also possible to join the fibers into fiber strands and to form fabrics or knitted fabrics from these fiber strands which lead to a multi-layer structure of the pressure transfer bodies 9.

1. A brake shoe for a disk brake with a support for a sintered brake lining, which support can be pressurized by the piston of at least one brake cylinder, wherein the support (7) comprises on the side facing the piston (5) of the brake cylinder (4) a heat-insulating, porous pressure transfer body (9) made of fibers bonded with artificial resin for the piston.

2. A brake shoe according to claim 1, wherein at least a predominant share of the fibers consists of carbon fibers.

3. A brake shoe according to claim 1, wherein the pressure transfer body (9) is inserted into a recess (8) of the support (7) for the brake lining (6).
